(19) United States
(12) Patent Application Publication
(10) Pub. No.: US 2009/0277772 A1
(43) Pub. Date: Nov. 12, 2009

(54) Process for Continous Production of Carbon Fibres

(75) Inventors: Mathias Kaiser, Karlsbad (DE); Lukas Alberts, Esslingen (DE); Frank Henning, Pfinztal (DE); Rudolf Emmerich, Kuppenheim (DE); Christian Hunyar, Karlsruhe (DE); Klaus-Dieter Nauenburg, Hanau (DE); Ralf Dreher, Ubstadt-Weiher (DE); Peter Elsner, Pfinztal (DE); Bernd Wohlmann, Dusseldorf (DE)

Correspondence Address: OLIFF & BERRIDGE, PLC, P.O. BOX 320850, ALEXANDRIA, VA, 22320-4850, US

(73) Assignee: TOHO TENAX CO., LTD., Sunto-gun (JP)

(21) Appl. No.: 12/226,325

(22) PCT Filed: Mar. 31, 2007
(86) PCT No.: PCT/EP2007/002909

§ 371 Date: Nov. 19, 2008

(30) Foreign Application Priority Data
Apr. 15, 2006 (EP) 06007926.6

(51) Int. Cl. B01J 19/12

(52) U.S. Cl. 204/157.47

(57) ABSTRACT

A process for continuous production of carbon fibres whereby stabilised precursor fibres are carbonised and graphitised with the help of high-frequency electromagnetic waves, characterised in that the stabilised precursor fibres are continuously conveyed, as the inner conductor of a coaxial conductor consisting of an outer and an inner conductor, through the coaxial conductor and a treatment zone; that the stabilised precursor fibres are irradiated in the treatment zone with high-frequency electromagnetic waves that are absorbed by the precursor fibres, which are thereby heated and converted into carbon fibres; and that the stabilised precursor fibres or carbon fibres are conveyed under an inert gas atmosphere through the coaxial conductor and the treatment zone.

The invention relates to a process for continuous production of carbon fibres whereby stabilised precursor fibres are carbonised and graphitised with the help of high-frequency electromagnetic waves.

Stabilised precursor fibres are fibres that have been converted into infusible fibres by process techniques that are known per se. Only infusible fibres of this type are suitable for the subsequent carbonisation steps necessary for the production of carbon fibres.

A process of this type for production of carbon fibres from pitch with the help of microwaves is known from U.S. Pat. No. 4,197,282. However, it is said of this method that the microwave treatment can be carried out only after preparatory thermal treatment. According to U.S. Pat. No. 4,197,282, the thermal treatment alters the precursor fibres to the extent that they can be activated by the high frequency of the microwaves. (Where the initial material is pitch, this transformation involves conversion to the mesophase.) The patent specification does not indicate the mechanism of action of the microwaves on the stabilised precursor fibres.

Fibres, yarns and strands of stabilised precursor fibres are poor conductors of electricity and moderately good absorbers of high-frequency electromagnetic waves such as microwaves. Irradiation with high-frequency electromagnetic waves initiates the transition to full carbonisation and increasing graphitisation, which leads to a marked increase in the electrical conductivity of the treated fibres.

When graphitisation is complete, the fibre behaves like a wire in the waveguide and causes strong distortions and disturbances in the electric field in the waveguide or resonator setup. If these are not controlled, they lead to inhomogeneities and disturbances that affect the homogeneity and process stability of the graphitisation, and in extreme cases could even trigger discharges or arcing, or lead to thermal vaporisation of the fibres.

Complex measuring equipment and control engineering were previously required for process control of homogeneous and continuous treatment of fibres with microwave energy. This could be the reason why the method has not so far been used on an industrial scale.

The object of the present invention is to provide a simple process for continuous production of carbon fibres whereby stabilised precursor fibres are carbonised and graphitised with the help of high-frequency electromagnetic waves, the process being economical in itself and viable in terms of the effort expended on process control.

This object is achieved by a process of the type cited in the introduction whereby the stabilised precursor fibres are continuously conveyed, as the inner conductor of a coaxial conductor consisting of an outer and an inner conductor, through the coaxial conductor and a treatment zone; the stabilised precursor fibres are irradiated in the treatment zone with high-frequency electromagnetic waves that are absorbed by the precursor fibres, which are thereby heated and converted into carbon fibres; and the stabilised precursor fibres or carbon fibres are conveyed under an inert gas atmosphere through the coaxial conductor and the treatment zone.

The high frequency electromagnetic waves are preferably microwaves.

While executing the process of the invention, it is surprisingly observed that in the delivery region, where the energy of the high-frequency electromagnetic waves or of the microwaves is delivered, a short reaction zone, usually a few centimetres in length, is formed, in which at least the greater part of the reaction for conversion of the carbon fibres occurs.

The delivery of microwave energy from a rectangular waveguide is known, for example from DE 10 2004 021 016 A1, where both the outer and the inner conductors are fixed components of the coaxial conductor. This type of coupling is used to bring microwave energy into hot process areas, because microwave energy can be transmitted with high power density with the help of coaxial conductors. The microwave energy, supplied from a waveguide, is delivered by a suitable device, such as a coupling cone, into the coaxial conductor.

An inert gas atmosphere can easily be maintained around the stabilised precursor fibres in the delivery region and in the coaxial conductor by, for example, positioning a tube that is transparent to high-frequency electromagnetic or microwave radiation inside the outer conductor of the coaxial conductor and inside the treatment zone, and passing the stabilised precursor fibres as the inner conductor, and also the inert gas, through this tube.

It was surprisingly found that by using a coupling device of a type in which the inner conductor of the coaxial conductor is substituted by the stabilised precursor fibres that are to be carbonised and that move through the coaxial conductor, these stabilised precursor fibres can easily be converted into carbon fibres. Because the stabilised precursor fibres have very low conductivity, their absorption of microwave energy in the delivery region causes them to become heated. With increased heating, the stabilised precursor fibres are converted into a material that initially absorbs better and is therefore better heated, and, as a result of this increased heating, also carbonises and graphitises, so that carbon fibres are obtained from the stabilised precursor fibres. As a result of this transformation, the conductivity of the carbon fibres that are formed increases continuously, causing the microwave energy to be increasingly delivered to the coaxial junction and preventing further treatment of the carbon fibres. The delivered microwave energy initiates the treatment of the stabilised precursor fibres in the coaxial conductor, so that a self-regulating system is set up on conveying the stabilised precursor fibres through the coaxial conductor.

The process of the invention is particularly distinguished in that the stabilised precursor fibres are conveyed through the coaxial conductor at such a speed that on leaving the coaxial conductor they have been carbonised or graphitised and are therefore carbon fibres.

It can also be advantageous if precarbonised precursor fibres are used to carry out the process of the invention. Although practically any known stabilised precursor fibres can be used for the process of the invention, stabilised precursor fibres made from polyacrylonitrile are most particularly suitable for this purpose. It has also proved advantageous to use nitrogen as the gas for producing the inert atmosphere through which the stabilised precursor fibres are conveyed in the coaxial conductor.

It is particularly favourable if the speed at which the stabilised precursor fibres are conveyed through the coaxial conductor is controlled via measurement of the electrical resistance of the carbon fibres formed. It has been found that the value of the electrical resistance allows inferences to be drawn about the quality of the carbon fibres. In carrying out the process of the invention, it was found that precursor fibres that have already been precarbonised have an electrical resistance in the region of 30 MΩ, while carbon fibres with good properties in regard to strength, elongation and modulus have electrical resistance of the order of a few ohms, for example in the range 10-50Ω. The electrical resistance is measured here by means of two copper electrodes positioned 50 cm apart on the fibres.

It is particularly advantageous if small amounts of oxygen are added to the inert gas atmosphere. This allows the oxidation step of the treatment, normally carried out after carbonisation or graphitisation is complete, to be performed in the process of the invention directly during carbonisation. The addition of oxygen can be effected by, for example, not removing the air contained between the precursor fibres before their introduction into the coaxial conductor. However, it is also readily possible to dose oxygen in a specific, uniform amount into the inert gas atmosphere.

The process of the invention is particularly favourably executed if the stabilised precursor fibres are conveyed through two or more successive reactors, each consisting of a coaxial conductor and treatment zone.

In what follows, equipment suitable for carrying out the process of the invention will be described in detail.

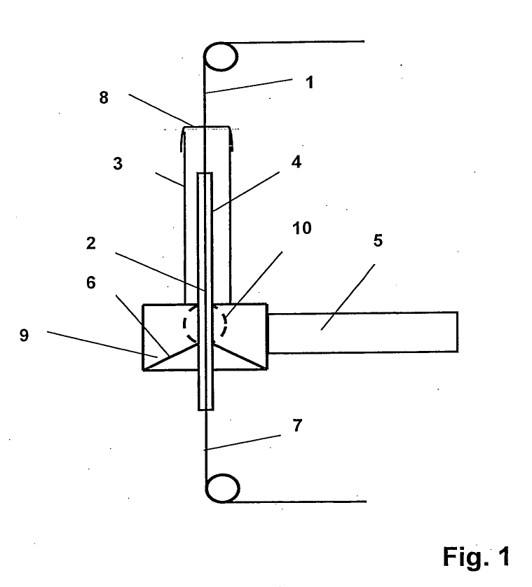

FIG. 1 is a schematic representation of a device in which delivery of microwave energy occurs via a coupling cone.

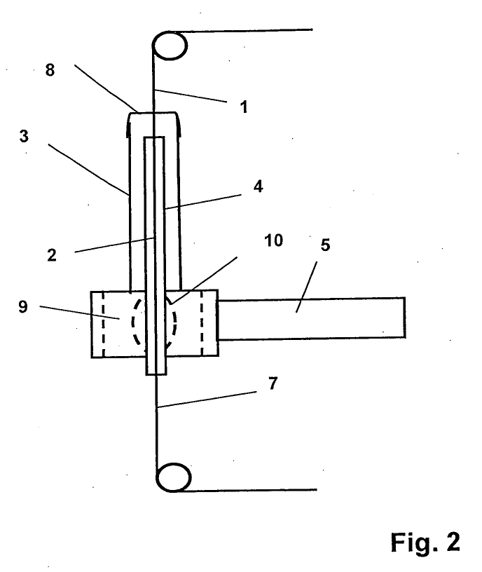

FIG. 2 is a schematic representation of a device in which a cavity resonator is used for delivery of the microwave energy.

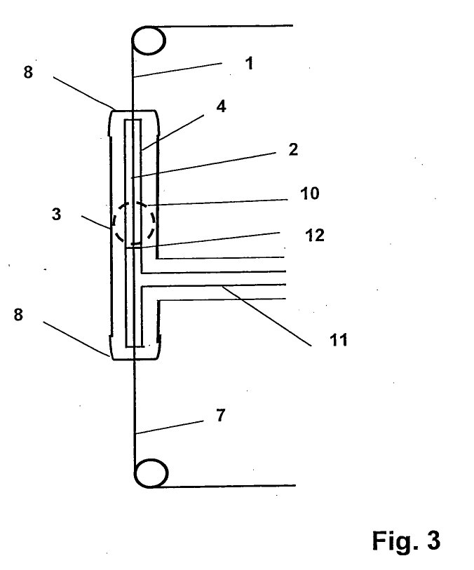

FIG. 3 is a schematic representation of a device in which a coaxial microwave feed is used for delivery the microwaves.

To execute the process of the invention, stabilised precursor fibres 1 are conveyed as inner conductors 2 through a coaxial conductor with an outer conductor 3. Around inner conductor 2, and within outer conductor 3 and resonator 9, a tube 4 is positioned that is transparent to high-frequency electromagnetic waves or microwaves, an inert gas for generation of an inert gas atmosphere being injected into the tube. The microwave energy supplied to a waveguide 5 is transmitted via coupling cone 6 (FIG. 1) or through a cavity resonator 9 (FIG. 2) to the coaxial conductor consisting of inner conductor 2 and outer conductor 3 in the treatment zone 10 that is formed, and as a result of the conversion into carbon fibres is delivered to the coaxial conductor 2,3. In FIG. 3, the microwaves are transmitted through a coaxial conductor whose inner conductor 11 is T-shaped and electrically conducting, through which the microwaves are diverted to treatment zone 10. This inner conductor 11 can for example be in the form of a tube. On leaving the inner conductor 11 at junction 12, the stabilised precursor fibres take over the function of the inner conductor 2 of the coaxial conductor whose outer conductor is numbered 3.

On leaving the treatment zone 10, the stabilised precursor fibres 1 have been converted into carbon fibres 7. A field distribution of the microwave energy in the form of standing waves is achieved in the coaxial conductor by means of a coaxial termination unit 8. Other embodiments suitable for carrying out the process of the invention are described in, for example, DE 26 16 217, EP 0 508 867 and WO 00/075 955.

The invention will now be described in detail with the help of the following examples.

The stabilised precursor fibres used were stabilised polyacrylonitrile precursor fibres that had been precarbonised, which were bundled into a strand of 12,000 filaments.

A cylindrical resonator with aluminium walls, similar to that in FIG. 2, from the firm of Muegge Electronics GmbH was used to couple the microwave energy. This resonator has a diameter of 100 mm and is designed to connect an R 26 rectangular waveguide to a microwave generator with a microwave output of 3 kW. The microwave energy generated is delivered to a coaxial conductor whose outer casing has an internal diameter of 100 mm.

The precarbonised stabilised precursor fibres were conveyed through the apparatus described above, under an inert gas atmosphere using nitrogen, the resulting carbon fibres being drawn off from the apparatus at various speeds. The microwave energy used was set to 2 kW. The carbon fibres obtained had the following properties:

| Drawing-off | | | |
|---|---|---|---|
| speed | Tensile strength | Modulus | Elongation |
| (m/h) | (Mpa) | (Gpa) | at break (%) |
| 50 | 3,200 | 220 | 1.4 |
| 150 | 3,100 | 218 | 1.4 |
| 240 | 3,500 | 217 | 1.5 |
| 420 | 2,700 | 180 | 1.4 |

1. A process for continuous production of carbon fibres whereby stabilized precursor fibres are carbonized and graphitized with the help of high-frequency electromagnetic waves, wherein stabilized precursor fibres are continuously conveyed, as an inner conductor of a coaxial conductor consisting of an outer and an inner conductor, through the coaxial conductor and a treatment zone; the stabilized precursor fibres are irradiated in the treatment zone with high-frequency electromagnetic waves that are absorbed by the precursor fibres, which are thereby heated and converted into carbon fibres; and the stabilized precursor fibres or carbon fibres are conveyed under an inert gas atmosphere through the coaxial conductor and the treatment zone.

2. The process according to claim 1, wherein microwaves are used as the high-frequency electromagnetic waves.

3. The process according to claim 1, wherein the stabilized precursor fibres are conveyed through the coaxial conductor at such a speed that on leaving the coaxial conductor they have been carbonized or graphitized and are therefore carbon fibres.

4. The process according to claim 1, wherein precarbonized precursor fibres are used.

5. The process according to claim 1, wherein the stabilized precursor fibres are made from polyacrylonitrile.

6. The process according to claim 1, wherein the gas used for producing the inert atmosphere through which the stabilized precursor fibres are conveyed is nitrogen.

7. The process according to claim 1, wherein the speed at which the stabilized precursor fibres are conveyed through the coaxial conductor is controlled via measurement of the electrical resistance of the carbon fibres formed.

8. The process according to claim 1, wherein small amounts of oxygen are added to the inert gas atmosphere.

9. The process according to claim 1, wherein the stabilized precursor fibres are conveyed through two or more successive reactors, each consisting of a coaxial conductor and treatment zone.
